(19) United States
(12) Patent Application Publication
(10) Pub. No.: US 2006/0158885 A1
(43) Pub. Date: Jul. 20, 2006

(54) Light integrator and/or beam shaping tunnel

(75) Inventors: Jeff Gohman, Hillsboro, OR (US); Mark Peterson, Lake Oswego, OR (US)

Correspondence Address: MAARTIN NIESTEN, INFOCUS CORPORATION, 277008 SW PARKWAY AVE., WILSONVILLE,, OR, 97070, US

(73) Assignee: InFocus Corporation

(21) Appl. No.: 11/039,198

(22) Filed: Jan. 18, 2005

(51) Int. Cl. F21V 9/00

(52) U.S. Cl. 362/293

(57) ABSTRACT

Embodiments of methods, apparatuses, devices and systems associated with a light integrator and/or beam shaping tunnel are disclosed.

### BACKGROUND

Light integrators, such as beam shaping tunnels, may be employed in digital and/or analog projection systems, and are known in the art. Light integrators may be used in projection systems such as these to distribute a circular light pattern produced by a light source into a square, rectangular and/or other shaped light pattern for use by other components of the projection system, for example. The length of the light integrator may at least partially effect how evenly the light may be distributed at the end of the integrator. For example, a longer light integrator may produce more evenly distributed light than a shorter light integrator. However, longer light integrators may increase the overall length and/or size of the projection system.

### BRIEF DESCRIPTION OF THE DRAWINGS

Subject matter is particularly pointed out and distinctly claimed in the concluding portion of the specification. The claimed subject matter, however, both as to organization and method of operation, together with objects, features, and advantages thereof, may best be understood by reference of the following detailed description when read with the accompanying drawings in which:

FIG. 1 is a schematic diagram of a projection system;

FIG. 2 is a schematic diagram of a projection system employing two light integrators, in accordance with at least one embodiment;

FIG. 3 is a schematic diagram of a projection system, in accordance with another embodiment;

FIG. 4 is a schematic diagram of a projection system, in accordance with yet another embodiment;

FIG. 5 is a schematic diagram of a projection system, in accordance with still yet another embodiment;.

FIG. 6 is a schematic diagram of a projection system, in accordance with still yet another embodiment;

FIG. 7 is a schematic diagram of a projection system, in accordance with still yet another embodiment;

FIG. 8 is a schematic diagram of a redirection component, in accordance with yet another embodiment; and

FIG. 9 is a schematic diagram of a projection system, in accordance with yet another embodiment

### DETAILED DESCRIPTION

In the following detailed description, numerous specific details are set forth to provide a thorough understanding of the claimed subject matter. However, it will be understood by those skilled in the art that the claimed subject matter may be practiced without these specific details. In other instances, well-known methods, procedures, components and/or circuits have not been described in detail so as not to obscure the claimed subject matter.

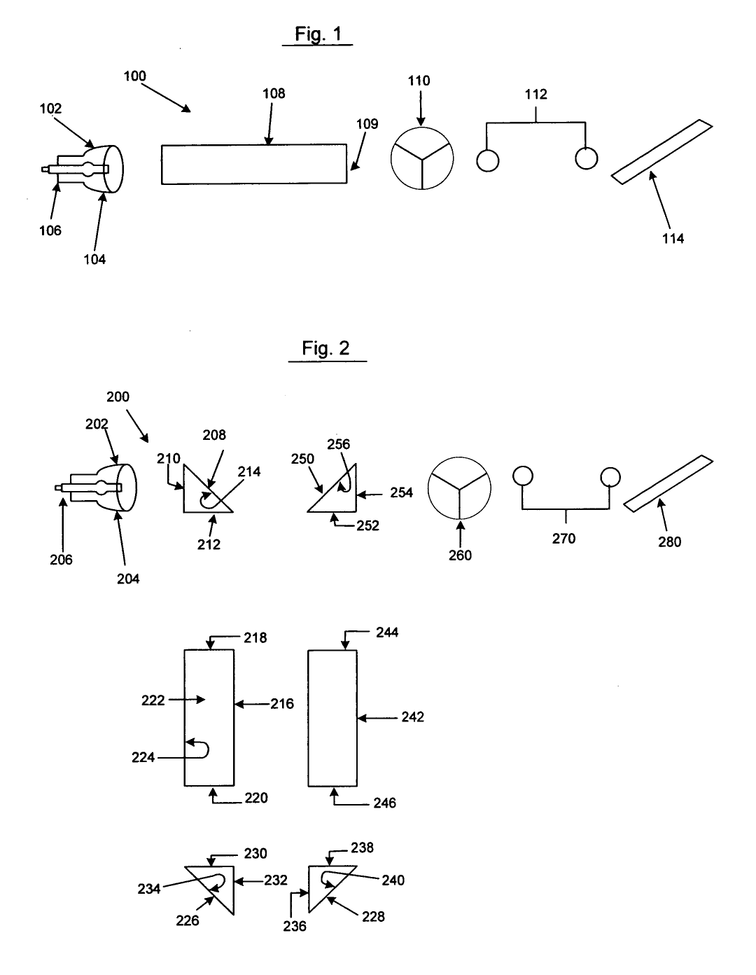

FIG. 1 is a schematic diagram of a projection system 100. Projection system 100 may include a light source 102. Light source 102 may include a light gathering reflector 104 and/or an arc lamp 106. Light gathering reflector 104 may comprise an at least partially concave reflective surface, such as an ellipsoid, a parabola and/or a variety of other shapes, for example. Arc lamp 106 may comprise a high-pressure mercury arc lamp, a halogen lamp, a tungsten-halogen lamp, and/or a variety of other lamps capable of producing sufficient light for projection system 100, for example. Projection system 100 may include a beam shaping tunnel and/or light integrator, such as integration tunnel 108. Integration tunnel 108 may in part function to distribute light, such as by distributing at least a portion of the light from light source 102 substantially across a tunnel aperture 109 of integration tunnel 108, for example. The evenness of the distributed light may at least in part depend on the length of integration tunnel 108, as mentioned above. For example, a longer integration tunnel 108 may result in light that may be more evenly distributed at tunnel aperture 109. Projection system 100 may also include a color wheel 110 that may function to filter at least a portion of the distributed light into red blue and/or green “RBG” light, which may be used to produce color images, although other color schemes and/or combinations of color schemes may be used. For example, projection system 100 may include one or more additional and/or alternative light filtering components capable of filtering the distributed light into colors corresponding to a color scheme such as RGB, for example. Alternatively, projection system 100 may not include a light-filtering component such as color wheel 110, and, in this embodiment, the projection system may be capable of producing monochrome images, for example. Projection system 100 may further include one or more optical components 112, which may comprise one or more lenses, for example, and may be configured to at least in part direct and/or focus the distributed light towards a image generating device, such as liquid crystal display “LCD” panel 114, which may be capable of producing images with the distributed light. Alternatively, LCD panel 114 may comprise one or more reflective LCD panels, transmissive LCD panels, liquid crystal on silicon panels, and/or a variety of other image producing devices, for example. In this context transmissive describes a material that may at least partially allow light to pass through. Additionally, projection system 100 may also include projection optics (not shown), such as lenses, for projecting produced images, for example.

FIG. 2 is a schematic diagram of a projection system 200, in accordance with at least one embodiment. Projection system 200 may comprise a light source 202, which may comprise a light gathering reflector 204 and/or an arc lamp 206. Light gathering reflector 204 may comprise an at least partially concave reflective surface, such as an ellipsoid, a parabola and/or a variety of other shapes, for example, and may further comprise a coating such as a dielectric coating formed on at least a portion of the surface of the reflector 204, for example. Arc lamp 206 may comprise a high-pressure mercury arc lamp, a halogen lamp, a tungsten-halogen lamp, and/or a variety of other lamps capable of producing sufficient light for projection system 200. Projection system 200 may further comprise a redirection component, such as first light reflecting component 208, which may be capable of at least partially reflecting and/or redirecting at least a portion of the light that may be produced by light source 202, for example. First light reflecting component 208 may comprise an input end 210 and an output end 212, which may each be transmissive and/or capable of at least partially allowing light to pass through, and a reflective component 214. Reflective component 214 may at least partially comprise a mirrored surface, such as a surface at least partially coated with reflective material, which may be capable of at least partially reflecting light, for example. In at least one embodiment, first light reflecting component 208 may at least partially comprise a prism such as a total internal reflective “TIR” prism, for example, although the claimed subject matter is not so limited.

Projection system 200 may further comprise a beam shaping tunnel and/or light integrator, such as first light integrating tunnel 216. First light integrating tunnel 216 may comprise a first end 218 and a second end 220. In at least one embodiment, first light integrating tunnel 216 may be positioned with first end 218 proximal to output end 212 of first light reflecting component 208. For example, first light integrating tunnel 216 may be positioned in direct contact with first reflecting component 208, such that first end 218 of first light integrating tunnel 216 may be at least partially contacting output end 212 of first light reflecting component 208. Alternatively, first light integrating tunnel 216 may be positioned such that there may be at least a partial gap, of around 100 microns or less for example, between first end 218 of first light integrating tunnel 216 and output end 212 of first light reflecting component 208. Additionally, first light integrating tunnel 216 may be positioned such that there is no contact between first end 218 of first light integrating tunnel 216 and output end 212 of first light reflecting component 208, for example. It should however be noted that claimed subject matter is not limited in this regard.

First light integrating tunnel 216 may further comprise a transmissive core 222 and/or a reflective outer casing 224. First light integrating tunnel 216 may be formed to have a variety of configurations, including a mirrored reflective outer casing 224 and/or a hollow transmissive core 222, for example. Alternatively, transmissive core 222 may comprise a material having a first index of refraction while reflective outer casing 224 may comprise a material having a second index of refraction, for example. In this embodiment, the first and second indexes of refraction may be chosen such that light traveling through transmissive core 222 may be at least partially reflected by reflective outer casing 224. Transmissive core 222 and reflective outer casing 224 may comprise materials such as, but not limited to, glass, doped glass, plastics, liquids, gas and/or a variety of other materials capable of having one or more of the above described characteristics, for example. Additionally, in an embodiment, transmissive core 222 may comprise a material such as glass and/or other materials as discussed above, while reflective outer casing 224 may comprise a polished outer surface of transmissive core 222, for example. It should be noted that claimed subject matter is of course not limited in this regard.

Projection system 200 may further comprise a second light reflecting component 226 and/or a third light reflecting component 228. Second light reflecting component 226 may comprise an input end 230, an output end 232 and/or a reflective component 234. Similarly, third light reflecting component 228 may comprise an input end 236, an output end 238 and/or a reflective component 240. In one embodiment, second light reflecting component 226 and/or third light reflecting component 228 may each have characteristics that are the same and/or substantially similar to those of first light reflecting component 208, although this is not a requirement. Second light reflecting component 226 may be positioned such that input end 230 of second light reflecting component 226 may be proximal to second end 220 of first light integrating tunnel 216. For example, input end 230 of second light reflecting component 226 may be positioned such that there may be at least partial contact between input end 230 and second end 220 of first light integrating tunnel 216. Alternatively, input end 230 of second light reflecting component 226 may be positioned such that there may be at least a partial gap, of around 100 microns or less for example, between input end 230 and second end 220 of first light integrating tunnel 216. Additionally, input end 230 of second light reflecting component 226 may be positioned such that there may be no contact between input end 230 and second end 220 of first light integrating tunnel 216, for example. Though it should be noted that claimed subject matter is not limited in this regard.

Third light reflecting component 228 may be positioned proximal to second light reflecting component 226, such that output end 232 of second light reflecting component 226 may be proximal to input end 236 of second light reflecting component 226. For example, input end 236 of third light reflecting component 228 may be positioned such that there may be at least partial contact between input end 236 of third light reflecting component 228 and output end 232 of second light reflecting component 236. Alternatively, input end 236 of third light reflecting component 228 may be positioned such that there may be at least a partial gap, of around 100 microns or less for example, between input end 236 of third light reflecting component 228 and output end 232 of second light reflecting component 226. Additionally, input end 236 of third light reflecting component 228 may be positioned such that there may be no contact between input end 236 of third light reflecting component 228 and output end 232 of second light reflecting component 226, for example. It should be noted however that claimed subject matter is not limited in this regard.

Projection system 200 may further comprise a second light integrating tunnel 242. Second light integrating tunnel 242 may comprise a first end 244 and a second end 246. In at least one embodiment, second light integrating tunnel 242 may have substantially similar and/or the same characteristics as first light integrating tunnel 216, although this is not a requirement. Second light integrating tunnel 242 may be positioned so that first end 244 of second light integrating tunnel may be proximal to output end 238 of third light reflecting component 228. For example, second light integrating tunnel 242 may be positioned so that first end 244 of second light integrating tunnel 242 may make contact with at least a portion of output end 238 of third light reflecting component. Aternatively, second light integrating tunnel 242 may be positioned so that there may be at least a partial gap, of around 100 microns or less for example, between first end 244 of second light integrating tunnel 242 and output end 238 of third light reflecting component. Additionally, second light integrating tunnel 242 may be positioned so that there may be no contact between first end 244 of second light integrating tunnel 242 and output end 238 of third light reflecting component, for example. It should however be noted that claimed subject matter is not limited in this regard.

Projection system 200 may further comprise a fourth light reflecting component 250. Fourth light reflecting component 250 may be positioned proximal to second light integrating tunnel 242. Fourth light reflecting component 250 may comprise an input end 252, an output end 254, and/or a reflective component 256. Fourth light reflecting component 250 may have characteristics that are the same, and/or substantially similar to those of first light reflecting component 208, although this is not a requirement. Fourth light reflecting component 250 may be positioned such that input end 252 of fourth light reflecting component 250 may be proximal to second end 246 of second light integrating tunnel 242. For example, input end 252 of fourth light reflecting component 250 may be positioned such that there may be at least partial contact between input end 252 and second end 246 of second light integrating tunnel 240. Alternatively, input end 252 of fourth light reflecting component 250 may be positioned such that there may be at least a partial gap, of around 100 microns or less for example, between input end 252 and second end 246 of second light integrating tunnel 242. Additionally, input end 252 of fourth light reflecting component 250 may be positioned such that there may be no contact between input end 252 and second end 246 of second light integrating tunnel 242, for example. It should however be noted that claimed subject matter is not limited in this regard.

Additionally, first light reflecting component 208, second light reflecting component 226, third light reflecting component 228, and/or fourth light reflecting component 250 may comprise a material having a first index of refraction while, at least one and/or more of their respective surfaces may comprise a material having a second index of refraction, for example. In this embodiment, the first and second indexes of refraction may be chosen such that light traveling through first light reflecting component 208, second light reflecting component 226, third light reflecting component 228, and/or fourth light reflecting component 250 may be at least partially reflected by the respective reflective component. First light reflecting component 208, second light reflecting component 226, third light reflecting component 228, and/or fourth light reflecting component 250 and their respective reflective components may comprise materials such as, but not limited to, glass, doped glass, plastics, liquids, gas and/or a variety of other materials capable of having one or more of the above described characteristics, for example. Additionally, in at least one embodiment, first light reflecting component 208, second light reflecting component 226, third light reflecting component 228, and/or fourth light reflecting component 250 may comprise a material such as glass and/or other materials as discussed above, while at least one and/or more of their respective surfaces may comprise a polished outer surface of first, second, third and/or fourth light reflecting components, for example. Additionally first, second, third and/or fourth light reflecting components may under some circumstances, at least in part integrate light in a similar manner to integration components described above and/or below. It should be noted that claimed subject matter is of course not limited in this regard.

Projection system 200 may further comprise a light filtering component, such as a color wheel 260 that functions to filter at least a portion of the distributed light into red blue and/or green “RBG” light, which may then be used to produce color images, although other color schemes and/or combinations may be used, and the claimed subject matter is not so limited. For example, projection system 200 may comprise one or more additional or alternative light filtering components capable of filtering the distributed light into colors corresponding to a color scheme such as RGB for producing color images. Alternatively, projection system 200 may not include a light filtering component such as color wheel 260, which may result in a projection system that produces monochrome images, for example. Additionally, in the case where projection system 200 includes color wheel 260, color wheel 260 may be positioned in a variety of other positions. For example, color wheel 260 may be disposed in between any of the above described components. It should be noted that claimed subject matter is not limited in this regard. Projection system 200 may further comprise optical components 270, which may comprise one or more lenses, for example. Optical component 270 may be capable of directing and/or focusing light, such as light distributed and/or filtered by color wheel 260 into RGB light towards an image generating component, such as a display panel 280, which may comprise a liquid crystal display “LCD” panel capable of producing images with the distributed RGB light. Display panel 280 may comprise one or more reflective LCD panels, transmissive LCD panels, liquid crystal on silicon panels, and/or a variety of other image producing devices, and the claimed subject matter is not limited in this respect. Projection system 200 may further comprise projection optics (not shown), such as one or more lenses, for projecting any produced images.

Alternatively, one or more of the above-described components may be positioned at larger relative distances from one another than shown and/or described. Additionally, one or more other optical components and/or one or more lenses (not shown) may be interposed between components that may be described as proximal to one another in the above description. For example, first light integrating tunnel 216 and first light reflecting component 208 may be positioned at greater distances from one another than described above, and optical components, such as one and/or more lenses (not shown) may be interposed between first light integrating tunnel 216 and first light reflecting component 208 to focus and/or direct light from output end 212 of first light reflecting component 208 towards first end 218 of first light integrating tunnel 216. Although, again, this is just one possible embodiment and the claimed subject matter is not limited in this respect.

By way of example, in operation, light generating component 202 may be implemented such that generated light may be incident upon first light reflecting component 208, such as at input end 210. At least a portion of the generated light may at least in part pass through input end 210 and/or at least in part be incident on reflective component 214. At least a portion of the generated light may then be at least in part reflected by reflective component 214, such as at least partially towards output end 212. At least a portion of the generated light may then pass through output end 212 towards first end 218 of first light integrating tunnel 216. In some circumstances, the generated light may be at least partially integrated by passing through first light reflecting component 208. At least a portion of the generated light may then pass through transmissive core 222, and/or be reflected by outer casing 224, such as when generated light may be incident upon reflective outer casing 224, for example. In this way, when implemented as described above, first light integrating tunnel 216 may function to at least partially alter a distribution of the generated light incident upon first end 218 of first light integrating tunnel 216 from an at least somewhat circular, elliptical, and/or other shaped distribution pattern into an at least somewhat square, rectangular, and/or other shaped distribution, depending at least in part on the particular shape of first light integrating tunnel 216 at second end 220 of light integrating tunnel 216, for example. Second and third redirecting components 226 and 228, respectively, may additionally function to redirect at least a portion of the light passing from second end 220 of first light integrating tunnel 216 towards first end 244 of second light integrating tunnel 242, such as in the same and/or a similar manner as described above in reference to first light redirecting component 208. For example, second redirection component 226 may receive light from second end 220 of first light integrating tunnel 216, and may reflect at least a portion of the light towards output end 232 of second light directing component, such as when the light may be incident upon reflective component 234, for example. Additionally, third light reflecting component 228 may receive light from output end 232 of second light reflecting component 226, such as into input end 236 of third light reflecting component 228. At least a portion of the received light may be at least partially reflected by reflecting component 242 of third light reflecting component 228 towards output end 238 of third light reflecting component. In some circumstances, the generated light may be at least partially integrated by passing through second light reflecting component 226 and/or third light reflecting component 228. Similarly to first light integrating tunnel 216, second light integrating tunnel 242 may at least partially distribute light between first end 244 and second end 246, such as by distributing the light more evenly between first end 244 and second end 246, for example. Light from second end 246 of second integrating tunnel 242 may then be at least partially redirected by fourth light reflecting component 250 towards color wheel 260, such as in a manner described in reference to first light reflecting component 208, for example. In one embodiment, light may be provided to input end 252 of fourth light reflecting component 250 and may be at least partially reflected by reflective component 256 of fourth light reflecting component 250 towards output end 254 of fourth light reflecting component 250. In some circumstances, the generated light may be at least partially integrated by passing through fourth light reflecting component 250. At least a portion of the light may then pass from output end 254 of fourth light reflecting component 250 towards color wheel 260, for example.

In one embodiment, projection system 200 may operate at least in part as described above and/or as further described below. At light source 202, light may be generated by arc lamp 206, and may be at least partially reflected along an optical path by light gathering reflector 204. First reflecting component 208 may be positioned along the optical path so that at least a portion of the generated light enters first reflecting component 208, and may additionally be at least partially redirected towards first light integrating tunnel 216. First light integrating tunnel 216 may alter at least a portion of the distribution of the generated light as the generated light passes through the tunnel, such as if the light may be reflected off of reflective outer casing 224, for example. The distribution of the generated light may be somewhat randomized within first light integrating tunnel 216, for example. At least a portion of the generated light may propagate from first light integrating tunnel 216 towards and/or into second redirecting component 226. Second redirecting component 226 may redirect at least a portion of the light towards and/or into third redirection component 228. At least a portion of the generated light may enter third redirection component 228, and may be redirected towards and/or into second light integrating tunnel 242. Second light integrating tunnel 242 may further distribute the generated light, such as in a manner similar to that described above in reference to first light integrating tunnel 216, for example. At least a portion of the generated light may then enter fourth redirection component 250. Fourth redirection component 250 may redirect at least a portion of the generated light towards and/or into color wheel 260. As the generated light passes at least partially through color wheel 260, the light may be filtered into one or more component colors, such as red, blue and green components, although other color combinations are possible, as explained previously. At least a portion of the filtered light may then pass through optical components 270, which may function to focus at least a portion of the light towards and/or onto display panel 280, which may be capable of producing one or more images, such as by selectively opening and/or closing pixels (not shown) of display panel 280. The produced image may then be projected onto a surface (not shown) by projection optics (not shown).

In operation, light integrating tunnels 216 and 242 may provide approximately the same and/or similar light distribution as a single light integrating tunnel having a length approximately the same as the combined length of light integrating tunnels 216 and 242, while projection system 200 may have a smaller system length than a system employing the single light integrating tunnel having the longer length. This may provide numerous advantages, such as increased design flexibility, more compact projection systems, and/or increased configurability, when designing a projection system, while still maintaining a desired light distribution for the projection system, for example.

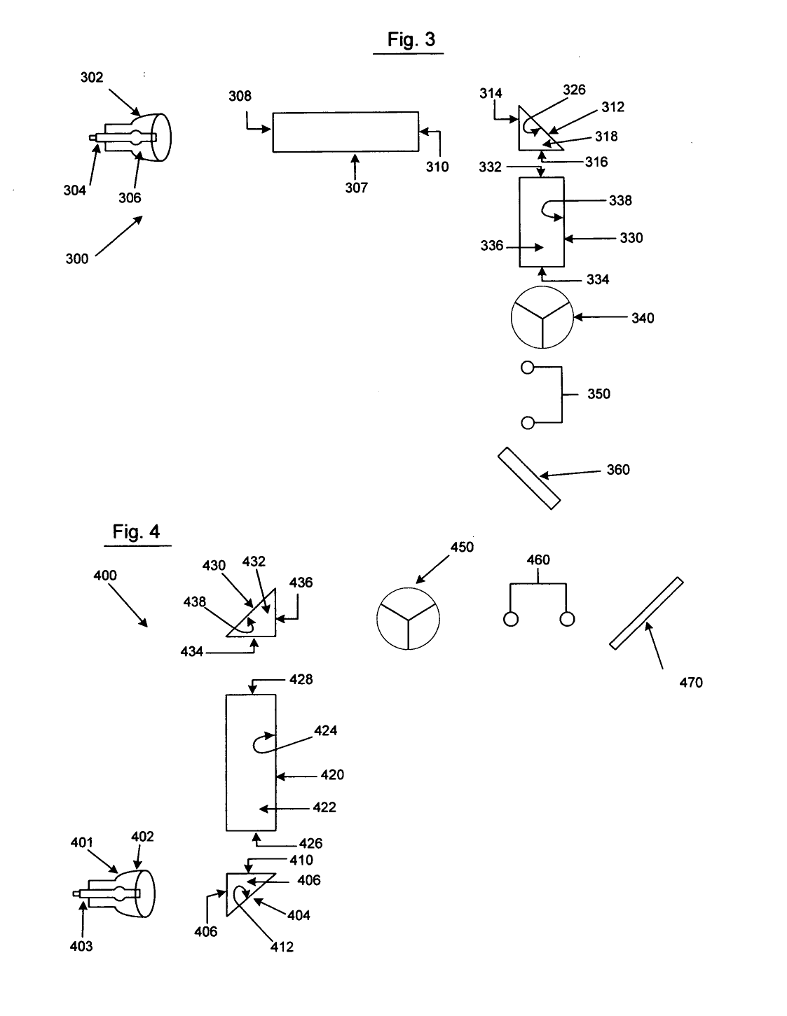

FIG. 3 is a schematic diagram of a projection system 300, in accordance with another embodiment. In this embodiment, projection system 300 may comprise a light source 302. Light source 302 may comprise an arc lamp 304 and/or a light gathering reflector 306, for example. Projection system 300 may further comprise a beam shaping tunnel and/or light integrator such as a first light integrating tunnel 307. First light integrating tunnel 307 may have characteristics that may be similar and/or the same as light integrating tunnels 216 and 242 of FIG. 2, for example, though this is not a requirement. First light integrating tunnel 307 may have a first end 308 and a second end 310. First light integrating tunnel 307 may be positioned such that first end 308 of first light integrating tunnel may be proximal to light source 302. First light integrating tunnel 307 may comprise a mirrored tunnel, a glass core with a doped glass cladding, doped glass core with a glass cladding, plastic core with plastic cladding having an at least somewhat different index of refraction that the plastic core, a transmissive core with a dichroic coating, and/or any variety of other materials, such as described in reference to light integrating tunnels 216 and/or 242 of FIG. 2, for example.

Projection system 300 may further comprise a first light redirection component 312. First light redirection component 312 may have characteristics which may be substantially similar, and/or the same as first light reflecting component 208, although this is not a requirement. First light redirection component 312 may have an input end 314 and an output end 316. First light redirection component 312 may be positioned such that input end 314 of first light redirection component 312 may be positioned proximal to second end 310 of first light integrating tunnel 306. For example, input end 314 of first light redirection component 312 may be positioned such that there may be at least partial contact with second end 310 of first light integrating component 306 and/or such that there may be at least a partial gap, of around 100 microns or less for example, between the input end 314 of first light redirection component 312 and second end 310 of first light integrating tunnel 306. Additionally, input end 314 of first light redirection component 312 may be positioned such that there may be no contact between the input end 314 of first light redirection component 312 and second end 310 of first light integrating tunnel 306, for example. It should be noted that claimed subject matter is not limited in this regard. First light redirection component 312 may further comprise a transmissive core 318 and a reflective back panel 320. Reflective back panel 320 may comprise a mirrored surface, a dichroic film or a variety of other materials, for example. Alternatively, first light redirection component 312 may comprise a prism, such as a TIR prism as discussed above, for example.

Projection system 300 may further comprise a second light integrating tunnel 330. Second light integrating tunnel 330 may comprise a first end 332 and a second end 334. Second light integrating tunnel 330 may be positioned such that first end 332 may be positioned proximal to output end 316 of first light redirection component 312. For example, second light integrating tunnel 330 may be positioned such that first end 332 may be positioned at least partially in contact with output end 316 of first redirection component 312. Alternatively, second light integrating tunnel 330 may be positioned such that there may be at least a partial gap, of around 100 microns or less for example, between first end 332 of second light integrating component 330 and output end 316 of first light redirecting component 312. Additionally, second light integrating tunnel 330 may be positioned such that there may be no contact between first end 332 of second light integrating component 330 and output end 316 of first light redirecting component 312, for example. It should however be noted that claimed subject matter is not limited in this regard. Second light integrating tunnel 330 may be similar in structure and function to first light integrating tunnel 306, in at least one embodiment. Second light integrating tunnel 330 may similarly comprise a transmissive core 336 and a reflective outer casing 338. Transmissive core 336 may comprise of a wide variety of materials including but not limited to air, plastic, glass, and/or liquid, as just a few examples. Reflective outer casing 338 may be formed of a variety of materials including but not limited to a mirrored surface, glass, plastic, gas, liquid and/or a dichroic coating, as just a few examples. In one embodiment, where transmissive core 336 and reflective outer casing 338 may comprise glass, plastic, gas, and/or liquid, the materials used for transmissive core 336 and reflective outer casing 338 may have different indexes of refraction such that light may be at least partially reflected by reflective outer casing 338, for example. Additionally, in an embodiment, transmissive core 336 may comprise a material such as glass and/or other materials as discussed above, while reflective outer casing 338 may comprise a polished outer surface of transmissive core 336, for example. It should be noted that claimed subject matter is of course not limited in this regard.

Projection system 300 may further comprise a color wheel 340, which may be positioned proximal to second end 334 of second light integrating tunnel. Color wheel 340 may operate to selectively filter portions of the light from second end 334 of second light integrating tunnel 330 into red, blue, and/or green light, which may then be used to produce color images, although other color schemes or combinations may be used, and the claimed subject matter is not so limited. Additionally, color wheel 340 may be positioned in a variety of other locations. For example, color wheel 340 may be disposed in between any of the above described components. It should be noted that claimed subject matter is not limited in this regard. Projection system 300 may further comprise optical components 350, such as one or more lenses, for example. Optical components 350 may be positioned proximal to color wheel 340, for example. Projection system 300 may further comprise a display panel, such as LCD panel 360, which may be positioned at a distance from optical components 350. Optical components 350 may be configured to have particular optical properties such that light passing through optical components 350 may be at least partially directed towards and/or focused onto at least a portion of LCD panel 360, for example. Although described as an LCD panel, as mentioned above, LCD panel 360 may comprise one or more reflective LCD panels, transmissive LCD panels, liquid crystal on silicon panels, and/or a variety of other image producing devices, and the claimed subject matter is not limited in this respect. Projection system 300 may further comprise projection optics (not shown), such as one or more lenses, for projecting any produced images, for example.

FIG. 4 is a schematic diagram of a projection system 400, in accordance with yet another embodiment. Projection system 400 may comprise a light generating component 401. Light generating component 401 may comprise a lamp 402, such as a high-pressure mercury arc lamp, a halogen lamp, a halogen-tungsten lamp and/or one or more of numerous other types of lights, as described above. Light generating component 402 may further comprise a reflective surface 403, which may be at least partially concave, such as a parabolic reflector and/or an ellipsoidal reflector, as just a few examples. Projection system 400 may further comprise a first redirection component 404, which may be capable of at least partially reflecting and/or redirecting at least a portion of the light produced by lamp 402, for example. First redirection component 404 may comprise a transmissive core 406, an input end 408, and output end 410 and/or a reflective back panel 412. Transmissive core 406 may be at least partially comprised of glass, plastic, liquid, gas, and/or any other material capable of at least partially allowing light to pass through, for example. Reflective back panel 412 may comprise a mirrored surface, a dichroic coating, glass, plastic, liquid, gas, and/or a variety of other materials. Alternatively, first redirection component 404 may comprise a prism, such as a TIR prism, for example.

Projection system 400 may further comprise a first light integrating component 420. First light integrating component 420 may comprise a transmissive core 422 and/or a reflective outer casing 424. First light integrating component 420 may comprise a mirrored reflective outer casing 424 and a hollow transmissive core 422, for example. Alternatively, transmissive core 422 may comprise a material having a first index of refraction while reflective outer casing 424 may comprise a material having a second index of refraction. In this embodiment, the first and/or second indexes of refraction may be chosen so that light traveling through transmissive core 422 may be at least partially reflected by reflective outer casing 424. Transmissive core 422 and reflective outer casing 424 may comprise materials such as, but not limited to, glass, doped glass, plastic, gas, liquid and/or a variety of other materials having substantially the above described characteristics, for example. Additionally, first light integrating component 420 may comprise a mirrored tunnel, a glass core with a doped glass cladding, doped glass core with a glass cladding, plastic core with plastic cladding having an at least somewhat different index of refraction than the plastic core, a transmissive core with a dichroic coating, or any variety of other materials, as described previously. Transmissive core 422 may comprise a wide variety of materials including but not limited to gas, plastic, glass, and/or liquid, to name but a few examples. Additionally, reflective outer casing 424 may comprise a variety of materials including but not limited to a mirrored surface, glass, plastic, liquid, and/or a dichroic coating, to name but few examples. In the case where transmissive core 422 and reflective outer casing 424 are formed of glass or plastic the materials used for transmissive core 422 and/or reflective outer casing 424 may have different indexes of refraction such that light may be at least partially reflected by reflective outer casing 424, for example. Additionally, in an embodiment, transmissive core 422 may comprise a material such as glass and/or other materials as discussed above, while reflective outer casing 424 may comprise a polished outer surface of transmissive core 422, for example. It should be noted that claimed subject matter is of course not limited in this regard.

First light integrating component 420 may further comprise a first end 426 and a second end 428. In one embodiment, first light integrating component 420 may be positioned so that first end 426 of first light integrating component 420 may be proximal to output end 410 of first redirection component 404. For example, first light integrating component 420 may be positioned so that first end 426 of first light integrating component 420 and output end 410 of first redirection component 404 may be at least partially in contact. Alternatively, first light integrating component 420 may be positioned such that there may be at least a partial gap, of around 100 microns or less for example, between first end 426 of first light integrating component 420 and output end 410 of first redirection component 404. Additionally, first light integrating component 420 may be positioned such that there may be no contact between first end 426 of first light integrating component 420 and output end 410 of first redirection component 404, for example. It should however be noted that claimed subject matter is not limited in this regard.

Projection system 400 may further comprise a second redirection component 430. Second redirection component 430 may comprise a transmissive core 432, an input end 434, an output end 436, and/or a reflective back panel 438. Transmissive core 432 may comprise glass, plastic, liquid, gas, and/or any number of other materials, for example. Reflective back panel 438 may comprise a mirrored surface, a dichroic coating, glass, plastic, and/or a variety of other materials. Alternatively, second redirection component 430 may comprise a prism, such as a TIR prism, for example.

Projection system 400 may further comprise a color wheel 450 that may filter at least a portion of the distributed light into red blue and/or green light, which may then be used to produce color images, although other color schemes or combinations may be used, and the claimed subject matter is not so limited. For example, projection system 400 may comprise one or more additional or alternative light filtering components capable of filtering the distributed light into colors corresponding to a color scheme such as RGB for producing color images, for example. Alternatively, projection system 400 may not include a light filtering component such as color wheel 450, which may result in a projection system that produces monochrome images, for example. Additionally, color wheel 450 may be positioned in a variety of other positions. For example, color wheel 450 may be disposed in between any of the above described components. It should be noted that claimed subject matter is not limited in this regard. Projection system 400 may further comprise optical components 460, which may comprise one or more lenses, for example. Optical components 460 may be capable of directing and/or focusing incident light towards a display panel 470, which may comprise an LCD panel, and may be capable of producing images with the incident light, for example. In this embodiment, display panel 470 may comprise one or more reflective LCD panels, transmissive LCD panels, liquid crystal on silicon panels, and/or a variety of other image producing devices, and the claimed subject matter is not limited in this respect. Projection system 400 may also comprise projection optics (not shown), such as one or more lenses, for projecting any produced images, for example.

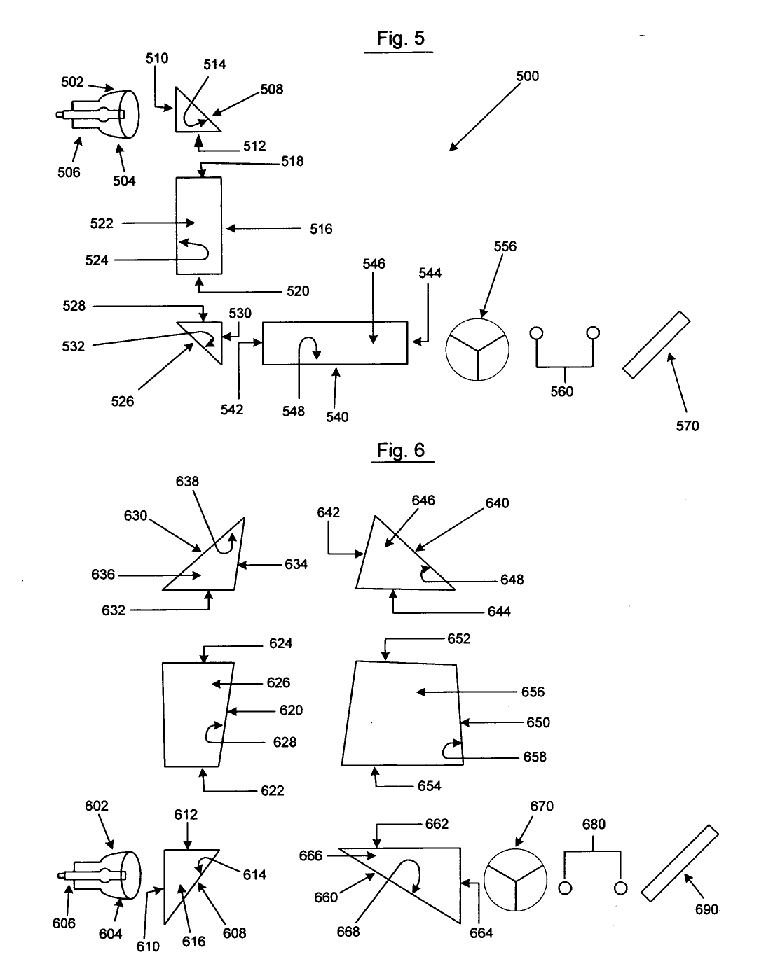

FIG. 5 is a schematic diagram of a projection system 500, in accordance with yet another embodiment. Projection system 500 may comprise a light source 502. Light source 502 may comprise a light gathering reflector 504 and/or an arc lamp 506. Light gathering reflector 504 may comprise an at least partially concave reflective surface, such as an ellipsoid, a parabola and/or a variety of other shapes, for example, and may further comprise a coating, such as a dielectric material formed on at least a portion of the surface of the reflector. Arc lamp 506 may comprise a high-pressure mercury arc lamp, a halogen lamp, a tungsten-halogen lamp, and/or a variety of other lamps producing sufficient light for projection system 500, for example.

Projection system 500 may further comprise a first light-reflecting component 508. First light reflecting component 508 may comprise an input end 510, an output end 512, which may each be capable of at least partially allowing light to pass through, and a reflective back panel 514. Back panel 514 may at least partially comprise a mirrored surface, such as a surface of plastic and/or glass at least partially coated with a material that at least partially reflects light. For example, back panel 514 may alternatively comprise a surface at least partially coated with a dichroic film. Alternatively, back panel 514 may comprise a material that at least partially reflects light. First light reflective component 508 may alternatively comprise a prism, such as a TIR prism, as discussed above.

Projection system 500 may further comprise a first light integrating tunnel 516. First light integrating tunnel 516 may comprise a first end 518 and a second end 220. In at least one embodiment, light integrating tunnel 516 may be positioned with first end 518 proximal to output end 512 of first light reflective component 508. For example, first light integrating tunnel 516 may be positioned such that first end 518 of first light integrating tunnel 516 may be at least partially contacting output end 512 of first light reflective component 508. Alternatively, first light integrating tunnel 516 may be positioned such that there may be at least a gap, of around 100 microns or less for example, between first end 518 of first light integrating tunnel 516 and output end 512 of first light reflective component 508. Additionally, first light integrating tunnel 516 may be positioned such that there may be no contact between first end 518 of first light integrating tunnel 516 and output end 512 of first light reflective component 508.

First light integrating tunnel 516 may comprise a transmissive core 522 and/or a reflective outer casing 524. First light integrating tunnel 516 may be formed to have a variety of configurations, including a mirrored reflective outer casing 524 and/or a hollow transmissive core-522, for example. Alternately transmissive core 522 may comprise a material having a first index of refraction while reflective outer casing 524 may comprise a material having a second index of refraction, for example. In this embodiment, the first and second indexes of refraction may be chosen so that light traveling through transmissive core 522 may be at least partially reflected by reflective outer casing 524. Transmissive core 522 and reflective outer casing 524 may comprise materials such as, but not limited to, glass, doped glass, plastics, gas, liquids, and/or a variety of other materials having one or more of the above described characteristics, for example. Additionally, first light integrating tunnel 516 may comprise a mirrored tunnel, a glass core with a doped glass cladding, doped glass core with a glass cladding, plastic core with plastic cladding having an at least somewhat different index of refraction than that the plastic core, a transmissive core with a dichroic coating, or any variety of other materials, for example. Additionally, in an embodiment, transmissive core 522 may comprise a material such as glass and/or other materials as discussed above, while reflective outer casing 524 may comprise a polished outer surface of transmissive core 522, for example. It should be noted that claimed subject matter is of course not limited in this regard.

Projection system 500 may further comprise a second light reflecting component 526. Second light reflecting component 526 may comprise an input end 528, an output end 530 and a reflective component 532. Second light reflecting component 526 may have characteristics that are the same, and/or substantially similar to those of first light reflecting component 208, for example. In one embodiment, second light reflecting component 526 may be positioned such that input end 528 of second light reflecting component 526 may be proximal to second end 520 of first light integrating tunnel 516. For example, input end 528 of second light reflecting component 526 may be positioned such that there may be at least partial contact between input end 528 and second end 520 of first light integrating tunnel 516. Alternatively, input end 528 of second light reflecting component 526 may be positioned such that there may be at least a partial gap, of around 100 microns or less for example, between input end 528 and second end 520 of first light integrating tunnel 516. Additionally, input end 528 of second light reflecting component 526 may be positioned such that there may be no contact between input end 528 and second end 520 of first light integrating tunnel 516, for example. It should however be noted that claimed subject matter is not limited in this regard.

Projection system 500 may further comprise a second light integrating tunnel 540 having a first end 542 and a second end 544. In at least one embodiment, second light integrating tunnel may have the same and/or substantially similar characteristics as first light integrating tunnel 216, although this is not a requirement. In one embodiment, second light integrating tunnel 540 may be positioned with first end 542 proximal to output end 530 of second light reflecting component 526. For example, second light integrating tunnel 540 may be positioned such that there may be at least partial contact between first end 542 of second light integrating tunnel and output end 530 of second light reflecting component 526. Alternatively, second light integrating tunnel 540 may be positioned so that there may be at least a partial gap, of around 100 microns or less for example, between first end 542 of second light integrating tunnel 540 and output end 530 of third light reflecting component. Additionally, second light integrating tunnel 540 may be positioned so that there may be no contact between first end 542 of second light integrating tunnel 540 and output end 530 of third light reflecting component.

Projection system 500 may further comprise a color wheel 550 that functions to filter at least a portion of the distributed light into red blue and/or green light, which may then be used to produce color images, although other color schemes or combinations may be used, and the claimed subject matter is not so limited. For example, projection system 500 may include one or more additional and/or alternative light filtering components capable of filtering the distributed light into colors corresponding to a color scheme such as RGB for producing color images, for example. Alternatively, projection system 500 may not include a light filtering component such as color wheel 550, which may result in a projection system that produces monochrome images, for example. Additionally, in the case where projection system 500 includes color wheel 560, color wheel 560 may be positioned in a variety of other positions. For example, color wheel 560 may be disposed in between any of the above described components. It should be noted that claimed subject matter is not limited in this regard. Projection system 500 may further comprise optical components 560, which may comprise one or more lenses, and may be capable of at least partially directing and/or focusing the light towards a display panel 570, which may comprise an LCD panel, and may be capable of producing images with the light, for example. Display panel 570 may comprise one or more reflective LCD panels, transmissive LCD panels, liquid crystal on silicon panels, and/or a variety of other image producing devices. Projection system 500 may also comprise projection optics (not shown), such as lenses, for projecting any produced images.

FIG. 6 is a schematic diagram of a projection system 600, in accordance with still yet another embodiment. Projection system 600 may comprise a light generating component 602. Light generating component 602 may comprise a light gathering reflector 604 and a light source 606. Light gathering reflector 604 may comprise an at least partially concave reflective surface, such as an ellipsoid and/or a parabola, for example. Light source 606 may comprise a high-pressure mercury arc lamp, a halogen lamp, a halogen-tungsten lamp, and/or a variety of other light sources, for example.

Projection system 600 may further comprise a first light redirecting component 608. First light redirecting component 608 may comprise an input end 610, an output end 612 and/or a reflective component 614. Reflective component 614 may comprise a mirrored surface, a dichroic material, glass, plastic, gas, liquid, and/or any other material that at least partially reflects incident light, for example. First redirecting component may further comprise a transmissive core 616 that may be at least partially transmissive of light. Transmissive core 616 may comprise, gas, glass, plastic, liquid, and/or any other material that may be at least partially transmissive of light, for example. In this configuration, light that may be incident upon input end 610 may be at least partially reflected by reflective component 614, and may be at least partially directed towards output end 610, for example. Alternatively, first light redirecting component 608 may comprise a prism, such as a TIR prism, for example.

Projection system 600 may further comprise a first tapered light integrating tunnel 620. First tapered light integrating tunnel 620 may comprise a first end 622 and a second end 624. First end 622 may be sized so that it may be the same and/or substantially similar to the size of output end 612 of first light redirecting component 608, although this is not a requirement. Second end 624 of first tapered light integrating tunnel 620 may be sized so that it may be at least somewhat larger and/or smaller than first end 622 of first tapered light integrating tunnel 620, such that the integrating tunnel 620 may be at least partially tapered, for example. First tapered light integrating tunnel 620 may further comprise a transmissive core 626 and a reflective outer casing 628. Transmissive core 626 may comprise glass, plastic, gas, liquid, and/or any material that may be at least partially transmissive with respect to light under some circumstances. Reflective outer casing 628 may comprise a mirrored surface, glass, plastic, gas, liquid, dichroic material, and/or any material that when at least partially surrounding transmissive core 626 may be at least partially reflective of light under some circumstances. Additionally, in an embodiment, transmissive core 626 may comprise a material such as glass and/or other materials as discussed above, while reflective outer casing 628 may comprise a polished outer surface of transmissive core 626, for example. It should be noted that claimed subject matter is of course not limited in this regard. In one embodiment, first tapered light integrating tunnel 620 may be positioned proximal to first light redirecting component 608, such that first end 622 of first tapered light integrating tunnel 620 may be at least partially in contact with output end 612 of first light redirecting component 608. Alternatively, first tapered light integrating tunnel 620 may be positioned proximal to first light redirecting component 608, such that there may be at least a partial gap, of around 100 microns or less for example, between first end 622 of first tapered light integrating tunnel 620 and output end 612 of first light redirecting component 608. Additionally, first tapered light integrating tunnel 620 may be positioned proximal to first light redirecting component 608, such that there may be no contact between first end 622 of first tapered light integrating tunnel 620 and output end 612 of first light redirecting component 608, for example. It should however be noted that claimed subject matter is not limited in this regard.

Projection system 600 may further comprise a second light redirecting component 630. Second light redirecting component 630 may comprise an input end 632 and an output end 634. In one embodiment, input end 632 may be sized so that it may be the same and/or substantially similar in size to second end 624 of first tapered light integrating tunnel 620, for example. Second light redirecting component 630 may further comprise a transmissive core 636 and a reflective component 638. Reflective component 638 may comprise a mirrored surface, a dichroic material, glass, plastic, gas, liquid and/or any other material that may at least partially reflects incident light under some circumstances. Transmissive core 636 may be at least partially transmissive with respect to light. For example, transmissive core 636 may comprise gas, glass, plastic, liquid, and/or any other material that may be at least partially transmissive of light under some circumstances. In this configuration, light that may be incident upon input end 632 may be at least partially reflected by reflective component 638, and may be at least partially directed towards output end 634, for example. Alternatively, second light redirecting component 630 may comprise a prism, such as a TIR prism, for example.

Projection system 600 may further comprise a third light redirecting component 640. Third light redirecting component 640 may comprise an input end 642 and an output end 644. In one embodiment, input end 642 may be sized so that it may the same and/or substantially similar in size to output end 634 of second light directing component 630, for example. Third light redirecting component 640 may further comprise a transmissive core 646 and a reflective component 648. Reflective component 648 may comprise a mirrored surface, a dichroic material, gas, glass, plastic, liquid and/or any other material that at least partially reflects incident light. In one embodiment, transmissive core 646 may be at least partially transmissive with respect to light. For example, transmissive core 646 may comprise gas, air, glass, plastic, liquid, and/or any one of a number of other materials. In this configuration, light that may be incident upon input end 642 may be at least partially reflected by reflective component 648, and may be at least partially directed towards output end 644. Alternatively, second light redirecting component 640 may comprise a prism, such as a TIR prism, for example.

Projection system 600 may further comprise a second tapered light integrating tunnel 650. Second tapered light integrating tunnel 650 may comprise a first end 652 and a second end 654. In one embodiment, first end 652 may be sized so that it may be the same and/or substantially similar to output end 644 of third light redirecting component 640, for example. In one embodiment, second end 654 of second tapered light integrating tunnel 650 may be sized so that it may be at least somewhat larger and/or smaller than first end 652 of second tapered light integrating tunnel 650, such that the integrating tunnel 650 may be at least partially tapered, for example. Second tapered light integrating tunnel 650 may further comprise a transmissive core 656 and a reflective outer casing 658. Transmissive core 656 may comprise glass, plastic, gas, liquid, and/or any material that may be at least partially transmissive with respect to light. Reflective outer casing 658 may comprise a mirrored surface, glass, plastic, gas, liquid, dichroic material, and/or any material that when at least partially surrounding transmissive core 626 may be at least partially reflective of light under some circumstances. Additionally, in an embodiment, transmissive core 656 may comprise a material such as glass and/or other materials as discussed above, while reflective outer casing 658 may comprise a polished outer surface of transmissive core 222, for example. It should however be noted that claimed subject matter is of course not limited in this regard. In one embodiment, second tapered light integrating tunnel 650 may be positioned proximal to third light redirecting component 640, such that first end 652 of second tapered light integrating tunnel 650 may be at least partially in contact with output end 644 of third light redirecting component 640. Alternatively, second tapered light integrating tunnel 650 may be positioned proximal to third light redirecting component 640, such that there may be at least a partial gap, of around 100 microns or less for example, between first end 652 of second tapered light integrating tunnel 650 and output end 644 of third light redirecting component 640. Additionally, second tapered light integrating tunnel 650 may be positioned proximal to third light redirecting component 640, such that there may be no contact between first end 652 of second tapered light integrating tunnel 650 and output end 644 of third light redirecting component 640, for example. Although again it should be noted that claimed subject matter is not limited in this regard.

Projection system 600 may further comprise a fourth light redirecting component 660. Fourth light redirecting component 660 may comprise an input end 662 and an output end 664. Input end 662 may be the same and/or substantially similar size as second end 654 of second tapered light integrating tunnel 650, for example. Fourth light redirecting component 650 may further comprise a transmissive core 666 and a reflective component 668. Reflective component 668 may comprise a mirrored surface, a dichroic material, glass, plastic, gas, liquid and/or any other material that at least partially reflects incident light under some circumstances. Transmissive core 666 may be at least partially transmissive with respect to light, in at least one embodiment. For example, transmissive core 666 may comprise, gas, glass, plastic, liquid, and/or any other material that may be at least partially transmissive of light. In this configuration, light that may be incident upon input end 662 may be at least partially reflected by reflective component 668 and at least partially directed towards output end 664. Alternatively, fourth light redirecting component 660 may comprise a prism, such as a TIR prism, for example.

Projection system 600 may further comprise a color wheel 670 that may filter at least a portion of the distributed light into red blue and/or green light, which may then be used to produce color images, although other color schemes or combinations may be used, and the claimed subject matter is not so limited. For example, projection system 600 may comprise one or more additional or alternative light filtering components capable of filtering the distributed light into colors corresponding to a color scheme such as RGB for producing color images, for example. Alternatively, projection system 600 may not include a light filtering component such as color wheel 670, which may result in a projection system that produces monochrome images, for example. Additionally, in the case where projection system 600 includes color wheel 670, color wheel 670 may be positioned in a variety of positions other than that shown in FIG. 6. For example, color wheel 670 may be disposed in between any of the above described components. It should be noted that claimed subject matter is not limited in this regard. Projection system 600 may further comprise optical components 680, which may comprise one or more lenses, for example. Optical components 680 may be capable of directing and/or focusing incident light towards a display panel 690, which may comprise an LCD panel, and may be capable of producing images with the incident light, for example. In this embodiment, display panel 690 may comprise one or more reflective LCD panels, transmissive LCD panels, liquid crystal on silicon panels, and/or a variety of other image producing devices. Projection system 600 may also include projection optics (not shown), such as lenses, for projecting any produced images.

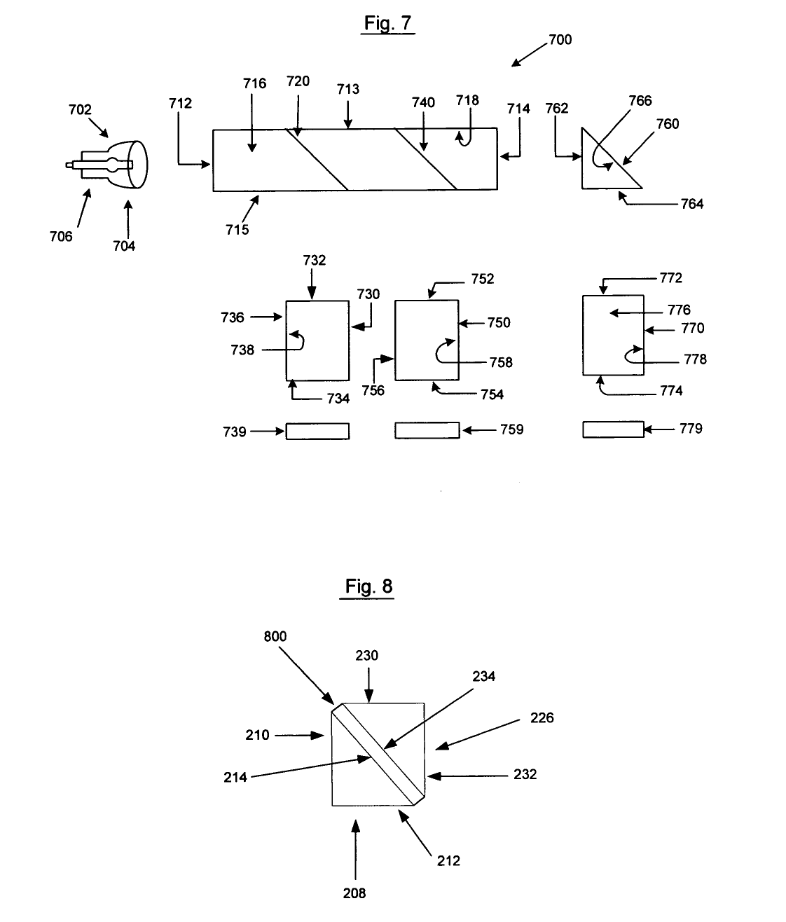

FIG. 7 is a schematic diagram of a projection system 700, in accordance with still yet another embodiment. Projection system 700 may comprise a light generating component 702. Light generating component 702 may comprise a light gathering reflector 704 and/or a light source 706. Light gathering reflector 704 may comprise an at least partially concave reflective surface such as a parabola, and/or an ellipsoid, for example. In one embodiment, a dielectric material may coat at least a portion of the surface of light gathering reflector 704, for example. Light source 706 may comprise a high-pressure mercury arc lamp, a halogen lamp, a halogen tungsten lamp, and/or a variety of other light sources capable of producing sufficient light for projection system 700, for example.

Projection system 700 may further comprise a light integrating/separating component 710. Light integrating/separating component 710 may comprise an input end 712, a first side 713, an output end 714, and/or a second side 715. Light integrating/separating component 710 may further comprise a transmissive core 716 and/or a reflective outer casing 718. Transmissive core 716 may comprise plastic, glass, liquid, gas, and/or any other material that may be at least partially transmissive with respect to light, under some circumstances. Additionally, reflective outer casing may comprise a mirrored surface, a dichroic material, glass, plastic, liquid, and/or any material that, on its own and/or when at least partially enclosing transmissive core 716, at least partially reflects light under some circumstances. Additionally, in an embodiment, transmissive core 716 may comprise a material such as glass and/or other materials as discussed throughout the above description, while reflective outer casing 718 may comprise a polished outer surface of transmissive core 716, for example. If should be noted that claimed subject matter is of course not limited in this regard.

Projection system 700 may further comprise a first light redirecting component 720. In one embodiment, first light redirecting component 720 may at least partially comprise a dichroic material, such as a film, for example, that may function to at least partially reflect light within a first frequency range and/or band while allowing at least a portion of light having one or more frequencies outside of the first frequency range and/or band to at least partially pass through first light redirecting component 720, for example. Alternatively, first light redirecting component 720 may comprise other materials, which may have similar properties, such that light within a first frequency range and/or band may be at least partially reflected by the material, while at least a portion of light having one or more frequencies outside of the first frequency range and/or band may be allowed to at least partially pass through.

First light redirecting component 720 may be positioned at least partially within integrating/separating component 710. First light redirecting component 720 may be positioned at an angle relative to first end 712 of first integrating/separating component 710, such as an approximately 45 degree angle, but the claimed subject matter is not limited to any particular angle, for example. In this particular configuration, when light is incident on first light redirecting component 720, at least a portion of light having one or more frequencies within the first frequency range and/or band may be at least partially reflected towards second side 715, and, under appropriate circumstances, may at least partially pass through second side 715, for example. Conversely, at least a portion of light having one or more frequencies outside of the first frequency range and/or band may at least partially pass through first light redirecting component 720, while being relatively unimpeded and/or unaltered, for example. Additionally, first light redirecting component 720 may comprise a pair of light redirecting components such as first light redirecting component 208 and second light redirecting component 226, in a configuration such as that shown in FIG. 8. In this embodiment first light redirecting component 720 may comprise first light redirecting component 208 and second light redirecting component 226 may be positioned such that there is contact between the spectrally dependent reflective back panel 214 and spectrally dependent reflective back panel 234, for example. Additionally first light redirecting component 208 and second light redirecting component may be affixed to one another such as by a cement or by a variety of other means, for example. Though again, it should be noted that claimed subject matter is of course not limited in this regard. In this context reflective back panel 214 and reflective back panel 234 may comprise one and/or more dichroic films, for example. In an embodiment there may alternatively be a dichroic film 800 positioned between, and/or affixed to one or more of reflective back panel 214 and/or reflective back panel 234, for example. Again, it should be noted that claimed subject matter is not limited in this regard.

Projection system 700 may further comprise a first light integrating component 730. First light integrating component 730 may comprise a first end 732 and a second end 734. In one embodiment, first light integrating tunnel 730 may be positioned with first end 732 proximal to first light redirecting component 720, such that at least a portion of light reflected by first light reflective component 720 may be at least in part directed towards first end 732 of first light integrating component 730. For example, first light integrating component 730 may be positioned such that first end 732 of first light integrating component 730 may be at least partially contacting light integrating/separating component 710. Alternatively, first light integrating component 730 may be positioned such that there may be a slight gap, of around 100 microns or less for example, between first end 732 of first light integrating component 730 and light integrating/separating component 710.

First light integrating component 730 may comprise a transmissive core 736 and/or a reflective outer casing 738. First light integrating component 730 may be formed to have a variety of configurations, including a mirrored reflective outer casing 738 and/or a hollow transmissive core 736, for example. Alternately transmissive core 736 may comprise a material having a first index of refraction while reflective outer casing 738 may comprise a material having a second index of refraction. The first and second indexes of refraction, in this embodiment, may be chosen so that at least a portion of light traveling through transmissive core 736 may be at least partially reflected by reflective outer casing 738. Transmissive core 736 and/or reflective outer casing 738 may comprise materials such as, but not limited to, gas, glass, doped glass, plastics, liquid and/or a variety of other materials having one or more of the above described characteristics, for example. Additionally, first light integrating component 730 may comprise a mirrored tunnel, a glass core with a doped glass cladding, doped glass core with a glass cladding, plastic core with plastic cladding having an at least somewhat different index of refraction than that the plastic core, a transmissive core with a dichroic coating, and/or any variety of other materials, for example. Additionally, in an embodiment, transmissive core 736 may comprise a material such as glass and/or other materials as discussed above, while reflective outer casing 738 may comprise a polished outer surface of transmissive core 736, for example. It should be noted that claimed subject matter is of course not limited in this regard. Projection system 700 may further comprise a first display panel 739. In one embodiment, first display panel 739 may comprise one or more reflective LCD panels, transmissive LCD panels, liquid crystal on silicon panels, and/or a variety of other image producing devices.

Projection system 700 may further comprise a second light redirecting component 740. In one embodiment, second light redirecting component 740 may comprise a dichroic material, such as a film, for example, that may function to reflect at least a portion of light within a second frequency range and/or band while allowing at least a portion of light having one or more frequencies outside of the second frequency range and/or band to at least partially pass through second light redirecting component 740. Alternatively, second light redirecting component 740 may comprise a different material, which may have similar properties, in that at least a portion of light within the second frequency range and/or band may be at least partially reflected by the material while at least a portion of light having one or more frequencies outside of the second frequency range and/or band may be allowed to at least partially pass through.

Second light redirecting component 740 may be positioned at least partially within integrating/separating component 710. Second light redirecting component 740 may be positioned at an angle relative to first end 712 of first integrating/separating component 710, such as an approximately 45 degree angle, but the claimed subject matter is not limited to any particular angle, for example. However, in this particular configuration, when light is incident on second light redirecting component 740, at least a portion of light having one or more frequencies within the second frequency range and/or band may be at least partially reflected towards second side 715, and, under appropriate circumstances, may at least partially pass through second side 715. Conversely, at least a portion of light having one or more frequencies outside of the second frequency range and/or band may pass through second light redirecting component 740.while being relatively unaltered, for example. Additionally, second light redirecting component 740 may comprise a pair of light redirecting components such as first light redirecting component 208 and second light redirecting component 226, in a configuration such as that shown in FIG. 8. In this embodiment second light redirecting component 740 may comprise first light redirecting component 208 and second light redirecting component 226 may be positioned such that there is contact between the spectrally dependent reflective back panel 214 and spectrally dependent reflective back panel 234, for example. Additionally first light redirecting component 208 and second light redirecting component may be affixed to one another such as by a cement or by a variety of other means, for example. Though again, it should be noted that claimed subject matter is of course not limited in this regard. In this context reflective back panel 214 and reflective back panel 234 may comprise one and/or more dichroic films, for example. In an embodiment there may alternatively be a dichroic film 800 positioned between, and/or affixed to one or more of reflective back panel 214 and/or reflective back panel 234, for example. Again, it should be noted that claimed subject matter is not limited in this regard.

Projection system 700 may further comprise a second light integrating component 750. Second light integrating component 750 may comprise a first end 752 and a second end 754. In one embodiment, second light integrating component 750 may be positioned with first end 752 proximal to second light redirecting component 740, such that at least a portion of light reflected by second light redirecting component 740 may be at least in part directed towards first end 752 of second light integrating component 750. For example, second light integrating component 750 may be positioned such that first end 752 of second light integrating component 750 may be at least partially contacting light integrating/separating component 710. Alternatively, second light integrating component 750 may be positioned such that there may be a slight gap, of around 100 microns or less for example, between first end 752 of second light integrating component 750 and light integrating/separating component 710.

Second light integrating component 750 may comprise a transmissive core 756 and/or a reflective outer casing 758. Second light integrating component 750 may be formed to have a variety of configurations, including a mirrored reflective outer casing 758 and a hollow transmissive core 756, for example. Alternately, transmissive core 756 may at least partially comprise a material having a first index of refraction while reflective outer casing 758 may at least partially comprise a material having a second index of refraction, for example. The first and second indexes of refraction may be chosen so that at least a portion of the light traveling through transmissive core 756 may be at least partially reflected by reflective outer casing 758. Transmissive core 756 and/or reflective outer casing 758 may comprise materials such as, but not limited to, gas, glass, doped glass, plastics, liquid and/or a variety of other materials having one or more of the above described characteristics, for example. Additionally, second light integrating component 750 may comprise a mirrored tunnel, a glass core with a doped glass cladding, doped glass core with a glass cladding, plastic core with plastic cladding having an at least somewhat different index of refraction than that the plastic core, a transmissive core with a dichroic coating, and/or any variety of other materials, for example. Additionally, in an embodiment, transmissive core 756 may comprise a material such as glass and/or other materials as discussed above, while reflective outer casing 758 may comprise a polished outer surface of transmissive core 756, for example. It should be noted that claimed subject matter is of course not limited in this regard. Projection system 700 may further comprise a second display panel 759 for producing images with the distributed RGB light. In at least one embodiment, second display panel 759 may comprise one or more reflective LCD panels, transmissive LCD panels, liquid crystal on silicon panels, and/or a variety of other image producing devices.

Projection system 700 may further comprise a third light redirecting component 760. In at least one embodiment, third light redirecting component 760 may at least partially comprise a dichroic material, such as a film, for example, that may function to at least partially reflect light within a third frequency range and/or band while allowing at least a portion of light having one or more frequencies outside of the second frequency range and/or band to at least partially pass through third light redirecting component 760, for example. Alternatively, third light redirecting component 760 may be at least partially comprised of a different material having similar properties, such that light within the third frequency range and/or band may be at least partially reflected by the material while at least a portion of light having one or more frequencies outside of the third frequency range and/or band may be allowed to at least partially pass through.

Third light redirecting component 760 may be positioned within and/or proximal to integrating/separating component 710. Third light redirecting component 760 may be positioned at an angle relative to first end 712 of first integrating/separating component 710, such as an approximately 45 degree angle, but the claimed subject matter is not limited to any particular angle, for example. However, in this particular configuration, when light may be incident on third light redirecting component 760, at least a portion of the light having one or more frequencies within the third frequency range and/or band may be at least partially reflected towards second side 715 and, under appropriate circumstances, may at least partially pass through second side 715, for example. Conversely, at least a portion of light having one or more frequencies outside of the third frequency range and/or band may at least partially pass through third light redirecting component 760 while being relatively unaltered, for example.

Third light redirecting component 760 may alternatively comprise an input end 762, an output end 764 and a reflective component 766. Third light redirecting component 760 may have characteristics that are the same and/or substantially similar to those of first light reflecting component 208, for example. In one embodiment, third light redirecting component 760 may be positioned such that input end 764 of third light redirecting component 760 may be proximal to second end 714 of light integrating/separating component 710. For example, input end 762 of third light redirecting component 760 may be positioned such that there may be at least partial contact between input end 762 and second end 714 of light integrating/separating tunnel 710. Alternatively, input end 762 of third light redirecting component 760 may be positioned such that there may be at least a partial gap, of around 100 microns or less for example, between input end 762 and second end 714 of light integrating/separating tunnel 710. Alternatively third light redirecting component 760 may comprise a prism, such as a TIR prism, for example.

Projection system 700 may further comprise a third light integrating component 770. Third light integrating component 770 may comprise a first end 772 and a second end 774. In one embodiment, third light integrating component 770 may be positioned with first end 772 proximal to third light redirecting component 760, such that light reflected by third light redirecting component 760 may be at least in part directed towards first end 772 of third light integrating component 770. For example, third light integrating component 770 may be positioned in direct contact with light integrating/separating component 710, such that first end 772 of third light integrating component 770 may be at least partially contacting light integrating/separating component 710. Alternatively, third light integrating component 770 may be positioned such that there may be a slight gap, of around 100 microns or less for example, between first end 772 of third light integrating component 770 and light integrating/separating component 710. Alternatively, for example, third light integrating component 770 may be positioned such that first end 772 of third light integrating component 770 may be at least partially contacting light integrating/separating component 710. Alternatively, third light integrating component 770 may be positioned such that there may be a slight gap, of around 100 microns or less for example, between first end 772 of third light integrating component 770 and light integrating/separating component 710.

Third light integrating component 770 may comprise a transmissive core 776 and/or a reflective outer casing 778. Third light integrating component 770 may be formed to have a variety of configurations, including a mirrored reflective outer casing 778 and/or a hollow transmissive core 776, for example. Alternatively, transmissive core 776 may comprise a material having a first index of refraction while reflective outer casing 778 may comprise a material having a second index of refraction, for example. The first and/or second indexes of refraction may be chosen so that at least a portion of light traveling through transmissive core 776 may be at least partially reflected by reflective outer casing 778. Transmissive core 776 and reflective outer casing 778 may comprise materials such as, but not limited to, gas, glass, doped glass, plastics, liquid and/or a variety of other materials having one or more of the above described characteristics, for example. Additionally, second light integrating component 770 may comprise a mirrored tunnel, a glass core with a doped glass cladding, doped glass core with a glass cladding, plastic core with plastic cladding having an at least somewhat different index of refraction than that the plastic core, a transmissive-core with a dichroic coating, and/or any variety of other materials, for example. Additionally, in an embodiment, transmissive core 766 may comprise a material such as glass and/or other materials as discussed above, while reflective outer casing 768 may comprise a polished outer surface of transmissive core 766, for example. It should be noted that claimed subject matter is of course not limited in this regard. Projection system 700 may further comprise a third display first panel 779, which may be configured to produce images with the distributed RGB light, for example. In one embodiment third display panel 779 may comprise one or more reflective LCD panels, transmissive LCD panels, liquid crystal on silicon panels, and/or a variety of other image producing devices.

Projection system 700 may further comprise projection optics 780, which may comprise one or more lenses, for example. In one embodiment, projection optics 780 may function to at least partially combine one or more images produced by first display panel 739, second display panel 759, and/or third display panel 779 and/or project one or more of the combined images onto a surface (not shown), for example. Additionally, the aforementioned first frequency band and/or range, second frequency band and/or range, and third frequency band and/or range may be chosen such that at least a portion of each band and/or range corresponds to one or more colors of a color scheme for producing color images, such as one or more colors of an RGB color scheme, for example.

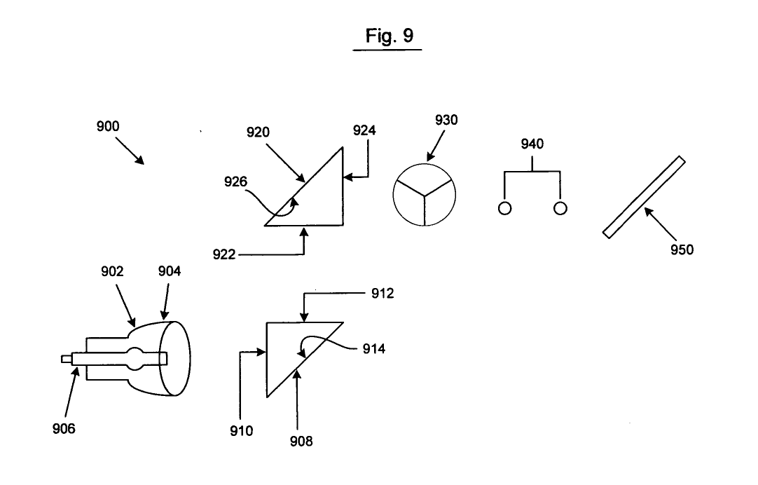

FIG. 9 is a schematic diagram of a projection system 900, in accordance with at least one embodiment. Projection system 900 may comprise a light source 902, which may comprise a light gathering reflector 904 and/or an arc lamp 906. Light gathering reflector 904 may comprise an at least partially concave reflective surface, such as an ellipsoid, a parabola and/or a variety of other shapes, for example, and may further comprise a coating such as a dielectric coating formed on at least a portion of the surface of the reflector 904, for example. Arc lamp 906 may comprise a high-pressure mercury arc lamp, a halogen lamp, a tungsten-halogen lamp, and/or a variety of other lamps capable of producing sufficient light for projection system 900. Projection system 900 may further comprise a redirection component, such as first light reflecting component 908, which may be capable of at least partially reflecting and/or redirecting at least a portion of the light that may be produced by light source 902, for example. First light reflecting component 908 may comprise an input end 910 and an output end 912, which may each be transmissive and/or capable of at least partially allowing light to pass through, and a reflective component 914. Reflective component 914 may at least partially comprise a mirrored surface, such as a surface at least partially coated with reflective material, which may be capable of at least partially reflecting light, for example. In at least one embodiment, first light reflecting component 908 may at least partially comprise a prism such as a total internal reflective “TIR” prism, for example, although the claimed subject matter is not so limited.

Projection system 900 may further comprise a second light reflecting component 920. Second light reflecting component 920 may comprise an input end 922, an output end 924 and/or a reflective component 926. In one embodiment, second light reflecting component 920 may have characteristics that are the same and/or substantially similar to those of first light reflecting component 208, although this is not a requirement. Second light reflecting component 920 may be positioned such that input end 922 of second light reflecting component 920 may be proximal to output end 912 of first light integrating tunnel 908. For example, input end 922 of second light reflecting component 920 may be positioned such that there may be at least partial contact between input end 922 and output end 912 of first light reflecting component 908. Alternatively, input end 922 of second light reflecting component 920 may be positioned such that there may be at least a partial gap, of around 100 microns or less for example, between input end 922 and output end 912 of first light reflecting component 908. Additionally, input end 922 of second light reflecting component 920 may be positioned such that there may be no contact between input end 922 and output end 912 of first light reflecting component 908, for example. Though it should be noted that claimed subject matter is not limited in this regard.

Additionally, first light reflecting component 908 and/or second light reflecting component 920 may comprise a material having a first index of refraction while, at least one and/or more of their respective surfaces, such as reflective back panels 914 and 926, for example, may comprise a material having a second index of refraction, for example. In this embodiment, the first and second indexes of refraction may be chosen such that light traveling through first light reflecting component 908 and/or second light reflecting component 920 may be at least partially reflected by the respective surfaces having the second index of refraction, for example. First light reflecting component 908 and/or second light reflecting component 920 and their respective reflective components may comprise materials such as, but not limited to, glass, doped glass, plastics, liquids, gas and/or a variety of other materials capable of having one or more of the above described characteristics, for example. Additionally, in at least one embodiment, first light reflecting component 908 and/or second light reflecting component 920 may comprise a material such as glass and/or other materials as discussed above, while at least one and/or more of their respective surfaces may comprise a polished outer surface of first light reflecting component 908 and/or second light reflecting component 920, for example. Additionally first light reflecting component 908 and/or second light reflecting component 908 may under some circumstances, at least in part integrate light in a similar manner to integration components and/or light tunnels described above and/or below. It should be noted that claimed subject matter is of course not limited in this regard.

Projection system 900 may further comprise a light filtering component, such as a color wheel 930 that functions to filter at least a portion of the distributed light into red blue and/or green “RBG” light, which may then be used to produce color images, although other color schemes and/or combinations may be used, and the claimed subject matter is not so limited. For example, projection system 900 may comprise one or more additional or alternative light filtering components capable of filtering the distributed light into colors corresponding to a color scheme such as RGB for producing color images. Alternatively, projection system 900 may not include a light filtering component such as color wheel 930, which may result in a projection system that produces monochrome images, for example. Additionally, in the case where projection system 900 includes color wheel 930, color wheel 930 may be positioned in a variety of other positions. For example, color wheel 930 may be disposed in between any of the above described components. It should be noted that claimed subject matter is not limited in this regard. Projection system 900 may further comprise optical components 940, which may comprise one or more lenses, for example. Optical component 940 may be capable of directing and/or focusing light, such as light distributed and/or filtered by color wheel 930 into RGB light towards an image generating component, such as a display panel 950, which may comprise a liquid crystal display “LCD” panel capable of producing images with the distributed RGB light. Display panel 950 may comprise one or more reflective LCD panels, transmissive LCD panels, liquid crystal on silicon panels, and/or a variety of other image producing devices, and the claimed subject matter is not limited in this respect. Projection system 900 may further comprise projection optics (not shown), such as one or more lenses, for projecting any produced images.

It will, of course, also be understood that, although particular embodiments have just been described, the claimed subject matter is not limited in scope to a particular embodiment or implementation. Additionally, in the preceding description, various aspects of the claimed subject matter have been described. For purposes of explanation, specific numbers, systems and/or configurations were set forth to provide a thorough understanding of the claimed subject matter. However, it should be apparent to one skilled in the art having the benefit of this disclosure that the claimed subject matter may be practiced without the specific details. In other instances, well-known features were omitted and/or simplified so as not to obscure the claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of the claimed subject matter.

1. An apparatus comprising:
an integration component having a first end and a second end; and
a first redirection component positioned proximal to the first end of the integration component, wherein the first redirection component is capable of at least partially reflecting light.

2. An apparatus according to claim 1, wherein the integration component comprises a light transmissive core and a reflective outer component, wherein the reflective outer component at least partially encloses the transmissive core, and is capable of at least partially reflecting light.

3. An apparatus according to claim 2, wherein the first redirection component comprises a first light reflecting component, wherein the first light reflecting component is capable of at least partially reflecting light, and is positioned at an angle relative to the first end of integration component.

4. An apparatus according to claim 3, wherein first redirection component further comprises an input end and an output end, and wherein the first light reflecting component is positioned proximal to the first end of the integration component, such that the first light reflecting component is capable of at least partially reflecting light incident on the input end towards the output end.

5. An apparatus according to claim 4, wherein the first redirection component is positioned proximal to the first end of the integration component, such that there is a gap between the input end of the first redirection component and the integration component.

6. An apparatus according to claim 4, further comprising a second redirection component comprising an input end, an output end and a second light reflecting component such that the second light reflecting component is capable of at least partially reflecting light incident on the input end towards the output end, wherein the first light reflecting component is positioned proximal to the second end of the integration component.

7. An apparatus according to claim 6, wherein the second redirection component is positioned proximal to the second end of the integration component, such that there is a gap between the input end of the second redirection component and the integration component.

8. An apparatus according to claim 1, wherein the first redirection component comprises a prism.

9. An apparatus according to claim 8 wherein the prism comprises a TIR prism.

10. An apparatus according to claim 2, wherein the light transmissive core comprises a gas and the reflective outer component comprises an at least partially mirrored surface.

11. An apparatus according to claim 2, wherein the integration component comprises a glass core having a first index of refraction and the reflective outer component comprises glass having a second index of refraction.

12. An apparatus according to claim 2, wherein the integration component comprises a plastic core having a first index of refraction and the reflective outer component comprises plastic having a second index of refraction.

13. An apparatus according to claim 2, wherein the first reflective component comprises a dichroic film, wherein the dichroic film is capable of at least partially reflecting light having a wavelength within a first wavelength band.

14. An apparatus according to claim 13, wherein the first reflective component is positioned at a first position at least partially within the integration component.

15. An apparatus comprising:
a light tunnel comprising a first end and a second end;
a first redirection component comprising a first surface that at least partially reflects light, wherein the first surface is positioned proximal to the first end of the light tunnel; and
a second redirection component comprising a second surface that at least partially reflects light, wherein the second surface is positioned proximal to the second end of the light tunnel.

16. An apparatus according to claim 15, wherein the first redirection component comprises a prism.

17. An apparatus according to claim 16 wherein the prism comprises a TIR prism.

18. An apparatus according to claim 16, wherein the first redirection component is positioned proximal to the first end of the light tunnel such that there is a gap between the light tunnel and the first redirection component.

19. An apparatus according to claim 15, wherein the second redirection component comprises a prism.

20. An apparatus according to claim 19 wherein the prism comprises a TIR prism.

21. An apparatus according to claim 19, wherein the second redirection component is positioned proximal to the second end of the light tunnel such that there is a gap between the light tunnel and the second redirection component.

22. An apparatus according to claim 15, wherein the first redirection component comprises a dichroic film.

23. An apparatus according to claim 22, wherein the first redirection component is positioned at least partially within the light tunnel.

24. An apparatus according to claim 15, where in the second redirection component comprises a dichroic film.

25. An apparatus according to claim 24, wherein the second redirection component is positioned at least partially within the light tunnel.

26. A projection system comprising:
a first redirection component comprising a first input end, a first output end, and a first reflecting component, wherein light incident on the first input end is at least partially reflected towards the first output end;
a first beam shaping tunnel comprising a first end, a second end, a light transmissive core, and a reflective outer casing that at least partially encloses the light transmissive core, and the first beam shaping tunnel is positioned so that the first end is positioned proximal to the first output end of the first redirection component.

27. A projection system according to claim 26 further comprising:
a second redirection component comprising a second input end, a second output end, and a second reflecting component, wherein the second input end is positioned proximal to the first beam shaping tunnel, such that light incident on the second input end is at least partially reflected towards the second output end.

28. A projection system according to claim 27, and further comprising:
a light source positioned proximal to the input end of the first redirection component; and
an image generating device.

29. A system according to claim 28, and further comprising optical components positioned so that light from the second output end is at least partially focused on the image generating device.

30. An apparatus comprising:
a first means for redirecting incident light having a distribution;
a means for altering the distribution of the incident light; and
a second means for redirecting incident light having a distribution.

31. An apparatus according to claim 30 further comprising:
a light generating means; and
an image generating means.

32. A projection system comprising:
a first light integration tunnel having a first end and a second end; and
a first redirection component comprising an input end, an output end, and a first reflective component, wherein said output end is positioned proximal to the first end of the first light integrating tunnel.

33. A method comprising:
positioning a first redirection component proximal to a light source;
positioning a first integration tunnel having first and second ends proximal to the first redirection component, such that the first end is proximal to the first redirection component; and
positioning a second redirection component proximal to the first integration tunnel, such that the second redirection component is proximal to the second end of the first integration tunnel.

34. An apparatus comprising:
a first redirection component comprising a first end and a second end, and capable of at least partially reflecting light,
a second redirection component comprising a first end and a second end, and capable of at least partially reflecting light, and positioned such that the first end of said second redirection component is positioned proximal to the second end of said first redirection component.

35. An apparatus according to claim 34, wherein said first redirection component comprises a prism.

36. An apparatus according to claim 35, wherein said second light redirection component comprises a prism.

37. An apparatus according to claim 36, wherein said second redirection component is positioned proximal to said first redirection component such that there is a gap between the second end of said first redirection component and the first end of said second redirection component.
